(19) United States
(12) Patent Application Publication
(10) Pub. No.: US 2023/0044067 A1
(43) Pub. Date: Feb. 9, 2023

(54) COMPLEX NETWORK-BASED ASSOCIATED ARTICLE STORAGE LOCATION OPTIMIZATION METHOD

(71) Applicant: ZHEJIANG UNIVERSITY, Hangzhou (CN)

(72) Inventors: Shuiliang FANG, Hangzhou (CN); Siyang WANG, Hangzhou (CN); Qiang FANG, Hangzhou (CN)

(21) Appl. No.: 17/969,686

(22) Filed: Oct. 20, 2022

Related U.S. Application Data
(63) Continuation of application No. PCT/CN2022/073420, filed on Jan. 24, 2022.

(30) Foreign Application Priority Data
Jan. 28, 2021 (CN) 202110116193.7

(51) Int. Cl. G06Q 10/08

(52) U.S. Cl. CPC G06Q 10/087

(57) ABSTRACT

A slotting optimization method of associated articles based on a complex network, mainly comprising the following steps: 1) constructing a weighted article association network using warehoused articles as network nodes, and joint retrieval frequencies of pairs of articles as edges; 2) performing sorting on the importance of an article node and determining a community initial node; 3) determining a community structure of the article association network; 4) determining whether a community peripheral node is an overlapping node according to the strength of an association relationship of said node with another community; and 5) determining a best slot for each article. The present method applies the complex network theory to the problem of slot allocation for associated article retrieval, overall distance and time for retrieving articles is reduced, and article retrieval efficiency is improved.

(FIG. 1)

### CROSS-REFERENCE TO RELATED APPLICATIONS

The present application is a continuation of International Application No. PCT/CN2022/073420, filed on Jan. 24, 2022, which claims priority to Chinese Application No. 202110116193.7, filed on Jan. 28, 2021, the contents of both of which are incorporated herein by reference in their entireties.

### TECHNICAL FIELD

The present disclosure relates to a slotting optimization method of associated articles based on a complex network, in particular to an optimization method for analyzing the association of warehoused articles based on a complex network theory and further allocating article slots accordingly.

### BACKGROUND

With the rapid development of China’s economy, the rack storage system has gradually replaced the outdated flat warehouse, and the allocation of slots is the key issue affecting the delivery efficiency of the rack storage system. In addition, because the process of article retrieval often contains two or more kinds of articles at the same time, there is a certain association in article retrieval. If the slots of associated articles can be optimally allocated according to the association, the efficiency of article retrieval will be greatly improved.

Common slot allocation strategies include fixed-location storage strategy, random storage strategy, sorted storage strategy, close-to-exit storage strategy, storage strategy based on turnover rate, storage strategy based on association and so on. However, most of the existing technologies are difficult to describe the intricate retrieval relationship among multiple articles, and the slot allocation strategy cannot be well combined with the actual layout characteristics of the warehouse. Therefore, it is necessary to design a slot allocation method that takes into account the relevance and retrieval frequency of articles from a global perspective to meet the needs of efficient warehouse management.

### SUMMARY

In order to overcome the shortcomings of the prior art, the present disclosure provides a slotting optimization method of associated articles based on a complex network. The method constructs and analyzes an article association network based on the complex network to describe the intricate relationships among a plurality of articles, and proposes the slotting optimization method of associated articles based on thearticle association networt.

The main contents of the optimization method of the present disclosure include: 1) constructing a weighted article association network using warehoused articles as network nodes, and joint retrieval frequencies of pairs of articles as edges; 2) performing sorting on the importance of an article node by comprehensively taking into account the closeness centrality of each article node and an importance level contribution value to each article node of a neighboring node thereof, and determining a core node, i.e., a community expansion starting point; 3) determining a community structure of the article association network by the capacity of each storage rack as a community volume limit and using weighted modularity and dependency as expansion criteria; 4) for a community peripheral node, determining whether said node is an overlapping node according to the strength of an association relationship of said node with another community; and 5) determining the slot allocation for each article by comprehensively taking into account the community structure of the article association network as well as a retrieval frequency of the article itself.

The specific steps are described as follows:

(1)A weighted article association network G = (V, E, W) is constructed using warehoused articles as network nodes, and joint retrieval frequencies of pairs of articles as edge, where V is a node set, i.e., a set of articles to be stored in a warehouse; E is a set of edges eᵢⱼ, where i, j ∈ V, eᵢⱼ. ∈ E, that is, a set of strong and weak associations between articles; W is a weight matrix, wᵢⱼ corresponds to the weight of eᵢⱼ, the value of which is equal to a frequency of retrieving articles i, j at the same time, which reflects a strength of the association between the articles nodes; if there are independent nodes, the independent nodes are deleted them from the association network;

(2)A community is a set of nodes in a complex network that are closely connected with each other but sparsely connected with other nodes. Aiming at the problems of core node selection, community structure initialization and the like in the article association network, the present disclosure comprehensively takes into account two factors, namely, the node closeness centrality and the importance level contribution value of the neighboring node, to determine a core node of the association network, that is, a community expansion seed node. The specific process includes:

(i) the node strength and the shortest path between two nodes are determined.

In the weighted article association network, the strength sᵢ of the node i is equal to a sum of the weights of the edges connected thereto:

$${S}_{i} = {\sum }_{j ∈ {N}_{i}} {w}_{i j}$$

where Nᵢ represents a set of neighboring node set of the node i, that is, a set of all the nodes associated with the node i.

The shortest path between any two nodes in the weighted network is the most vulnerable branch, that is:

$${d}_{i f}^{w} = min \left[\left(M - {w}_{i {h}_{l}}\right) + … \left(M - {w}_{{h}_{n} j}\right)\right]$$

where hₙ is a midway node of each branch of i, j and M is a large number, generally max wᵢⱼ +1.

(ii) The closeness centrality of the node is calculated according to the shortest path.

The closeness centrality of each node is equal to the reciprocal of a sum of the shortest paths from the node to all other nodes multiplied by a number of other nodes, that is:

$${C}_{c} \left(i\right) = \frac{n - 1}{{\sum }_{i \neq j} {d}_{i j}^{w}}$$

where n is a total number of the nodes in the network.

(iii) The importance of an article node is sorted according to the closeness centrality of the article node and an importance level contribution value to the article node of a neighboring node thereof.

For an article association weighted network with the number of nodes being n wᵢⱼsᵢ and the average strength being 〈s〉, the node i will contribute

$$\frac{{w}_{i j} {s}_{i}}{{\left〈s\right〉}^{2}}$$

of the importance level thereof to a neighboring node j thereof; if an edge weight between the node j and the node i is greater or the strength of the node is greater, then the importance level contribution of the node i to the node j will be greater; the importance level Cᵢ(i) of the node is obtained by comprehensively taking into account the closeness centrality of the node and importance level contribution values to the node of all neighboring nodes:

$${C}_{i} \left(i\right) = {C}_{c} \left(i\right) \times {\sum }_{j = 1 , j \neq i}^{n} {C}_{c} \left(j\right) {δ}_{i j} {w}_{i j} {s}_{j} / {\left〈s\right〉}^{2}$$

where δᵢⱼ represents the connectivity between two nodes, which is 1 in case of connection, and otherwise 0. Then the volumes of communities and the number of communities are first determined according to the total number of storage racks in the warehouse, the capacities of the storage racks and the number of nodes in the article association network, and finally the core node, i.e., the community expansion starting point, is determined according to the number of the communities and the sorting of the importance of the article node. Users can set the volumes and number of communities according to the specific layout of the warehouse. If there are n storage racks in total, the number of communities can be set to n, or the volumes of the communities can be determined according to the rack capacity, which can be set according to the needs. Then, the composition of the core nodes is determined according to the importance sorting of the nodes and the number of the communities. For example, if the number of the storage racks is n, the number of the communities is determined to be n, and the core nodes are the nodes with the top n in importance.

(3) As for the determination of the community structure of the article association network, the present disclosure adopts weighted modularity and weighted dependency as the community expansion criteria. Specifically, firstly, the neighboring nodes of each core node are added into a set of expanded candidate nodes of each community, and a modularity increment ΔQ^{w} of each node in the set of candidate nodes to join the corresponding community is calculated:

$$Δ {Q}^{w} = \left[\frac{\sum {w}_{{c}_{j}}^{i n} + {\sum }_{j ∈ {C}_{j}} {w}_{i , j}}{2 w} - {\left(\frac{\sum {w}_{{C}_{j} + {S}_{i}}}{2 w}\right)}^{2}\right] - \left[\frac{\sum {w}_{{c}_{j}}^{i n}}{2 w} - {\left(\frac{{\sum w}_{{c}_{j}}}{2 w}\right)}^{2} - {\left(\frac{{s}_{i}}{2 w}\right)}^{2}\right]$$

$$w = \frac{{\sum }_{i = 1}^{n} {\sum }_{j = 1}^{n} {w}_{i j}}{2}$$

where w represents a total weight value of the edges in the weighted network,

$$\sum {w}_{{c}_{j}}^{i n}$$

represents a sum of the edge weights in the community,

$${\sum }_{j ∈ {C}_{j}} {w}_{i , j}$$

represents a sum of weights of all edges connecting the node i and the nodes in the community Cⱼ, and

$$\sum {w}_{{C}_{j}}$$

represents a sum of weights of all edges associated with the nodes in the community; then a node with the largest modularity increment is selected to join the community; if the node has joined other communities, the modularity changes of the node when the node belongs to two communities are compared; if the modularity increment caused by the node joining a new community is greater than the modularity increment that keeps the node in an original community, the node is deleted from the original community and join the new community; this process is iterated until the community structure no longer changes and meets the requirements or Δ [symbol] ^{w} is less than 0; if there is still an independent node at this time, the dependency D_{i,c}′ of the node on a neighboring community C is calculated, a neighboring community that has not reached the community volume is selected according to dependency sorting, and the node is added to the neighboring community,

$${D}_{i , c} ' = \frac{{\sum }_{j ∈ C} {w}_{i , j}}{{S}_{i}}$$

(4) As for the possible community overlapping situation in the article network, the present disclosure determines the composition of the overlapping nodes by comparing the weighted modularity increment. Specifically, firstly, a node on the edge of the community and connected with other communities is added to a set U of potential overlapping nodes, and the modularity increment

$$Δ {\text{Q}}_{j n}^{w} '$$

of each potential overlapping node joining other communities is calculated; then the modularity increment

$$Δ {\text{Q}}_{j}^{w} '$$

that keeps the node in the original community is calculated, and if a difference between

$$Δ {\text{Q}}_{j n}^{w} '$$

and

$$Δ {\text{Q}}_{j}^{w} '$$

is less than

$$\frac{5}{2 w} ,$$

it is considered that the potential overlapping node has overlap with other communities; finally a number of truly overlapping nodes between two communities is calculated, and a degree of overlap between communities is determined by dividing the number by a sum of the nodes of the two communities.

(5) After the community structure of the article network is determined, the present disclosure proposes a slot allocation strategy that comprehensively considers the community structure of the article association network and the retrieval frequency of the articles themselves. Specifically, the core of this step is to formulate a slot allocation strategy that matches the current situation of the warehouse according to the warehouse layout and the community structure divided in step (4).

Taking the double-zone single-channel warehouse shown in FIG. 2 as an example, first, the retrieval frequency of each divided community in step (4) is sorted, and the community is allocated to each roadway one by one according to the ranking of the community; if there are still free storage racks in the roadway after a community is allocated, the overlapping degree among various communities is taken into account, and high overlapping communities with an overlapping degree higher than 10% are placed on other storage racks in the same roadway; if the number of the high overlapping communities is greater than the number of remaining storage racks, it is determined which high overlapping community the remaining storage racks belong to according to the community retrieval frequency; if there is no high overlapping community with an overlapping degree higher than 10%, the remaining storage racks are allocated according to the retrieval frequency of each community; then the slots in the rack are allocated. Since retrieval across the roadway must be performed via a roadway entrance under such a layout, no matter which roadway the overlapping community of an overlapping articles is located in, the distance between the overlapping community and the article can be reduced by placing the article closer to the roadway entrance in the original community. Accordingly in the present disclosure, an evaluation function Sᵢ is adopted to determine the slot arrangement of the article in the community:

$${S}_{i} = α \frac{C O {I}_{i}}{max C O {I}_{{C}_{j}}} + β δ \frac{{\sum }_{j n = 1}^{J N} {\sum }_{j * ∈ {C}_{j n}}^{} {w}_{i , j *}}{{\sum }_{j ∈ {C}_{j}}^{} {w}_{i , j}}$$

where COIᵢ represents a retrieval frequency of the article i; maxCOl_{Cj} represents a maximum retrieval frequency of the articles in the community;

$${\sum }_{j * ∈ {C}_{j n}}^{} {w}_{i , j *}$$

represents a sum of the weights of the connecting edges of an overlapping article i and an overlapping community Cⱼₙ; when there is more than one overlapping community of i, for example, there are JN overlapping communities,

$${\sum }_{j n = 1}^{J N} {\sum }_{j * ∈ {C}_{j n}}^{} {w}_{i , j *} ,$$

which represents a sum of weights of the connecting edges of the overlapping article i and all the external overlapping communities to which the overlapping article belongs;

$${\sum }_{j ∈ {C}_{j}}^{} {w}_{i , j}$$

represents a sum of weights of the connecting edges of the overlapping article i and the community Cⱼ to which the overlapping article really belongs; δᵢ is a variable of 0-1; if i is an overlapping article, then δᵢ=1, otherwise 0; α, β represent the weights of the two major components of the evaluation function, α + β =1; because the strength of the internal relationship between the overlapping article and the community to which it belongs is close to that between the overlapping article and external overlapping community, α, β can both be 0.5, and α can be moderately higher than β if the warehouse pays more attention to the retrieval frequency of the article itself; then the arrival time of each slot in the rack is calculated. t = t_{walk} + tᵣₑₜᵣᵢₑᵥₐₗ in a manual picking warehouse, that is, a sum of a walking time and a vertical pick-up time after standing; the matching between articles and slots is completed according to the scoring and sorting of the evaluation function of the article and the sorting of the slot arrival time; if there are independent nodes, they are allocated to spare slots according to the retrieval frequency.

Compared with the prior art, the present disclosure has the following beneficial effects. (1) The slotting optimization method based on a complex network provided by the present disclosure fully considers the association of each article with all other articles, and overcomes the problem that the traditional association rule mining method can hardly describe the complicated association relationship among multiple articles. (2) compared with intelligent algorithms such as genetic algorithm and simulated annealing algorithm, the present disclosure adopts a complex network theory to deal with the association between articles, and has more advantages in solving efficiency; if the warehouse needs to adjust the slots according to the demand change after a period of time, the slot arrangement can be provided more quickly by the method provided by the present disclosure. (3) The present disclosure fully combines the community discovery strategy, the slot allocation strategy and the actual layout mode of the warehouse, so that the slot allocation result is more in line with the actual operation situation of the warehouse. (4) The present disclosure can also be applied to other fields of slot allocation, such as supermarket articles distribution system and pharmacy storage system.

### BRIEF DESCRIPTION OF DRAWINGS

FIG. 1 shows the overall process of the slotting optimization method of associated articles based on a complex network;

FIG. 2 is a schematic diagram of a double-zone single-channel warehouse;

FIG. 3 is a schematic diagram of the slot allocation process based on the community structure and retrieval frequency of article (taking the double-zone single-channel warehouse in FIG. 2 as an example);

FIG. 4 is a schematic diagram of the construction of article association network;

FIG. 5 shows the community allocation result and the overlapping node distribution diagram in the articles association network.

### DESCRIPTION OF EMBODIMENTS

The technical solution of the present disclosure will be further explained with reference to the accompanying drawings.

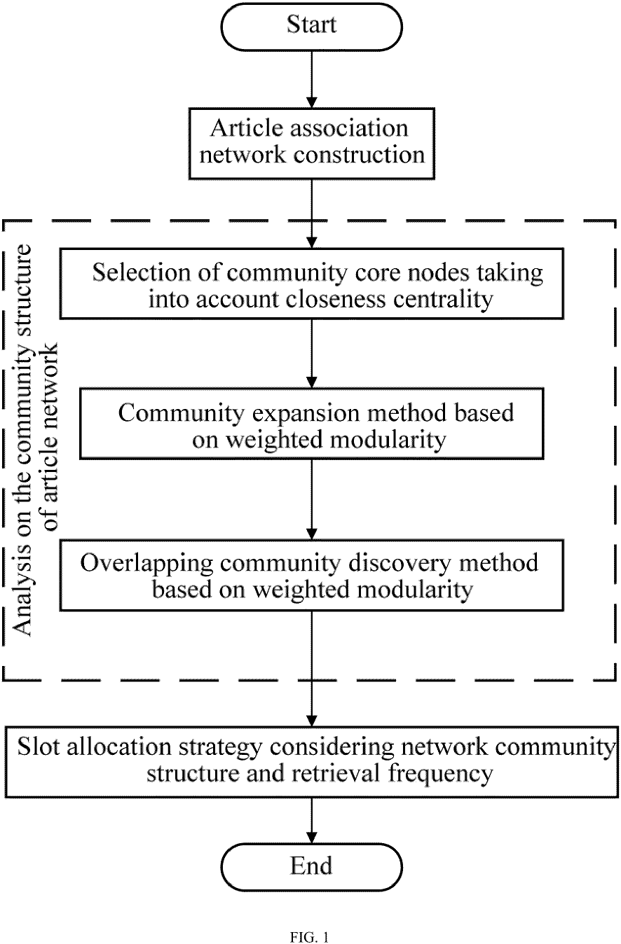

A slotting optimization method of associated articles based on a complex network, as shown in FIG. 1, includes the following steps:

Step (1): constructing a weighted article association network.

In the present disclosure, a weighted article association network G = (V, E, W) is constructed using warehoused articles as network nodes, and joint retrieval frequencies of pairs of articles as edge, where V is a node set, i.e., a set of articles to be stored in a warehouse; E is a set of edges eᵢⱼ, where i, j ∈ V, eᵢⱼ ∈ E , that is, a set of strong and weak associations between articles; W is a weight matrix, wᵢⱼ corresponds to the weight of eᵢⱼ, the value of which is equal to a frequency of retrieving articles i,j at the same time, which reflects a strength of the association between the articles nodes; if there are independent nodes, the independent nodes are deleted them from the association network.

Step (2): performing sorting on the importance of an article node by comprehensively taking into account the closeness centrality of each article node and an importance level contribution value to each article node of a neighboring node thereof, and determining a core node, i.e., a community expansion starting point.

First, the node strength and the shortest path between two nodes are determined. In the weighted article association network, the strength sᵢ of the node i is equal to a sum of the weights of the edges connected thereto:

$${S}_{i} = {\sum }_{j ∈ {N}_{i}}^{} {w}_{i j}$$

where Nᵢ represents a set of neighboring node set of the node i, that is, a set of all the nodes associated with the node i.

The shortest path between any two nodes in the weighted network is the most vulnerable branch, that is:

$${d}_{i j}^{w} = min \left[\left(M - {w}_{i {h}_{1}}\right) + ... \left(m - {w}_{{h}_{n} j}\right)\right]$$

where hₙ is a midway node of each branch of i, j and M is a large number.

Then, the closeness centrality of the node is calculated according to the shortest path. The closeness centrality of each node is equal to the reciprocal of a sum of the shortest paths from the node to all other nodes multiplied by the number of other nodes, that is:

$${C}_{c} \left(i\right) = \frac{n - 1}{{\sum }_{i \neq j}^{} {d}_{i j}^{w}}$$

where n is a total number of the nodes in the network.

Next, the importance of an article node is sorted according to the closeness centrality of the article node and an importance level contribution value to the article node of a neighboring node thereof. For an article association weighted network with the number of nodes being n and the average strength being 〈s〉, the node i will contribute

$$\frac{{w}_{i j} {s}_{i}}{{\left〈s\right〉}^{2}}$$

of the importance level thereof to a neighboring node j thereof; if an edge weight between the node j and the node i is greater or the strength of the node [symbol] is greater, then the importance level contribution of the node i to the node j will be greater; the importance level Cᵢ(i) of the node is obtained by comprehensively taking into account the closeness centrality of the node and importance level contribution values to the node of all neighboring nodes:

$${C}_{i} \left(i\right) = {C}_{c} \left(i\right) \times {\sum }_{j = 1 , j \neq i}^{n} {C}_{c} \left(j\right) {δ}_{i j} {w}_{i j} {s}_{j} \text{} / \text{} {\left〈s\right〉}^{2}$$

where δᵢⱼ represents the connectivity between two nodes, which is 1 in case of connection, and otherwise 0. Then the volumes of communities and the number of communities are determined according to the total number of storage racks in the warehouse, the capacities of the storage racks and the number of nodes in the article association network, and finally the core node, i.e., the community expansion starting point, is determined according to the number of the communities and the sorting of the importance of the article node.

Step (3): determining the community structure of the article association network by taking into account the capacity of the rack.

Firstly, the neighboring nodes of each core node are added into a set of expanded candidate nodes of each community, and a modularity increment ΔQ^{w} of each node in the set of candidate nodes to join the corresponding community is calculated:

$$\begin{matrix}Δ {Q}_{w} = \left[\frac{\sum {w}_{{C}_{j}}^{i n} + {\sum }_{j ∈ {C}_{j}} {w}_{i , j}}{2 w} - {\left(\frac{\sum {w}_{{C}_{j} + {S}_{i}}}{2 w}\right)}^{2}\right] - \\ \left[\frac{\sum {w}_{{C}_{j}}^{i n}}{2 w} - {\left(\frac{\sum {w}_{{C}_{j}}}{2 w}\right)}^{2} - {\left(\frac{{S}_{i}}{2 w}\right)}^{2}\right]\end{matrix}$$

$$w = \frac{{\sum }_{i = 1}^{n} {\sum }_{j = 1}^{n} {w}_{i j}}{2}$$

where w represents a total weight value of the edges in the weighted network,

$$\sum {w}_{{C}_{j}}^{i n}$$

represents a sum of the edge weights in the community,

$${\sum }_{j ∈ {C}_{j}} {w}_{i , j}$$

represents a sum of weights of all edges connecting the node i and the nodes in the community Cⱼ, and

$$\sum {w}_{{C}_{j}}$$

represents a sum of weights of all edges associated with the nodes in the community; then a node with the largest modularity increment is selected to join the community; if the node has joined other communities, the modularity changes of the node when the node belongs to two communities are compared; if the modularity increment caused by the node joining a new community is greater than the modularity increment that keeps the node in an original community, the node is deleted from the original community and join the new community; this process is iterated until the community structure no longer changes and meets the requirements or ΔQ^{w} is less than 0; if there is still an independent node at this time, the dependency Dᵢ,_{c}′ of the node on a neighboring community C is calculated, a neighboring community that has not reached the community volume is selected according to dependency sorting, and the node is added to the neighboring community,

$${D}_{i , C} ' = \frac{{\sum }_{j ∈ C} {w}_{i , j}}{{S}_{i}}$$

Step (4): determining overlapping nodes with strong association with other communities.

Firstly, a node on the edge of the community and connected with other communities is added to a set U of potential overlapping nodes, and the modularity increment

$$Δ {\text{Q}}_{j n}^{w} '$$

of each potential overlapping node joining other communities is calculated; then the modularity increment

$$Δ {\text{Q}}_{j}^{w} '$$

that keeps the node in the original community is calculated, and if a difference between

$$Δ {\text{Q}}_{j n}^{w} '$$

and

$$Δ {\text{Q}}_{j}^{w} '$$

is less than

$$\frac{5}{2 w} ,$$

it is considered that the potential overlapping node has overlap with other communities; finally a number of truly overlapping nodes between two communities is calculated, and a degree of overlap between communities is determined by dividing the number by a sum of the nodes of the two communities.

Step (5): determining the slot allocation for each article by comprehensively taking into account the community structure of the article association network as well as a retrieval frequency of the article itself.

The core of this step is to formulate a slot allocation strategy that matches the current situation of the warehouse according to the warehouse layout and the community structure divided in step (4).

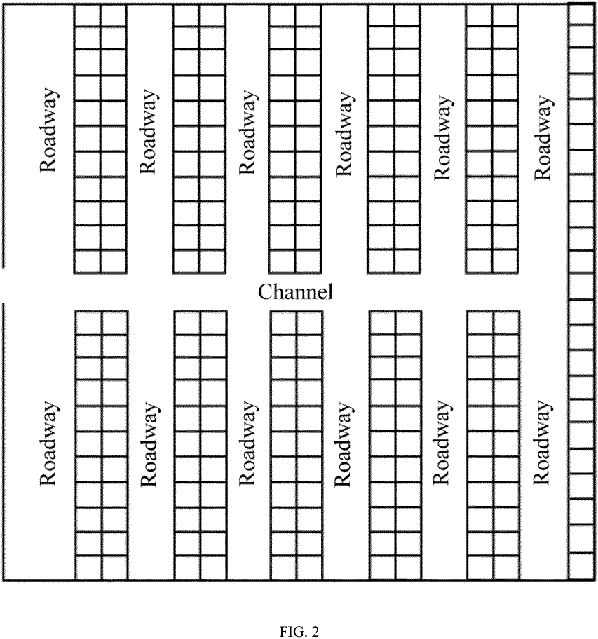

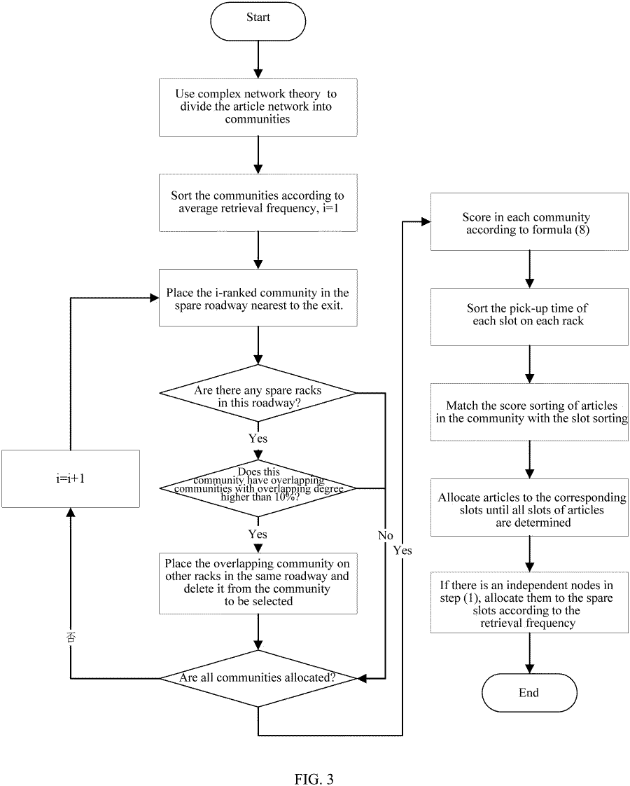

Taking the double-zone single-channel warehouse (shown in FIG. 2) as an example, first, the retrieval frequency of each divided community in step (4) is sorted, and the community is allocated to each roadway one by one according to the ranking of the community; if there are still free storage racks in the roadway after a community is allocated, the overlapping degree among various communities is taken into account, and high overlapping communities with an overlapping degree higher than 10% are placed on other storage racks in the same roadway; if the number of the high overlapping communities is greater than the number of remaining storage racks, it is determined which high overlapping community the remaining storage racks belong to according to the community retrieval frequency; if there is no high overlapping community with an overlapping degree higher than 10%, the remaining storage racks are allocated according to the retrieval frequency of each community; then the slots in the rack are allocated. Since retrieval across the roadway must be performed via a roadway entrance under such a layout, no matter which roadway the overlapping community of an overlapping articles is located in, the distance between the overlapping community and the article can be reduced by placing the article closer to the roadway entrance in the original community. Accordingly in the present disclosure, an evaluation function Sᵢ is adopted to determine the slot arrangement of the article in the community:

$${S}_{i} = a \frac{C O {I}_{i}}{max C O {I}_{{C}_{j}}} + β {δ}_{\text{i}} \frac{{\sum }_{j n = 1}^{J N} {\sum }_{j * ∈ {C}_{j n}} {w}_{i , j *}}{{\sum }_{j ∈ {C}_{j}} {w}_{i , j}}$$

where COIᵢ represents a retrieval frequency of the article i; maxCOI_{cj} represents a maximum retrieval frequency of the articles in the community;

$${\sum }_{j * ∈ {C}_{j n}} {w}_{i , j *}$$

represents a sum of the weights of the connecting edges of an overlapping article i and an overlapping community Cⱼₙ; when there is more than one overlapping community of i, for example, there are JN overlapping communities, which represents a sum of weights of the connecting edges of the overlapping article i and all the external overlapping communities to which the overlapping article belongs;

$${\sum }_{j ∈ {C}_{j}} {w}_{i , j}$$

represents a sum of weights of the connecting edges of the overlapping article i and the community C_{J} to which the overlapping article really belongs; δᵢ is a variable of 0-1; if i is an overlapping article, then δᵢ=1, otherwise 0; a, β represent the weights of the two major components of the evaluation function, a + β = 1; because the strength of the internal relationship between the overlapping article and the community to which it belongs is close to that between the overlapping article and external overlapping community, a, β can both be 0.5, and α can be moderately higher than β if the warehouse pays more attention to the retrieval frequency of the article itself; then the arrival time of each slot in the rack is calculated. t = t_{walk} + tᵣₑₜᵣᵢₑᵥₐₗ in a manual picking warehouse, that is, a sum of a walking time and a vertical pick-up time after standing; the matching between articles and slots is completed according to the scoring and sorting of the evaluation function of the article and the sorting of the slot arrival time; if there are independent nodes, they are allocated to spare slots according to the retrieval frequency.

The method in this embodiment is further explained by a specific example below.

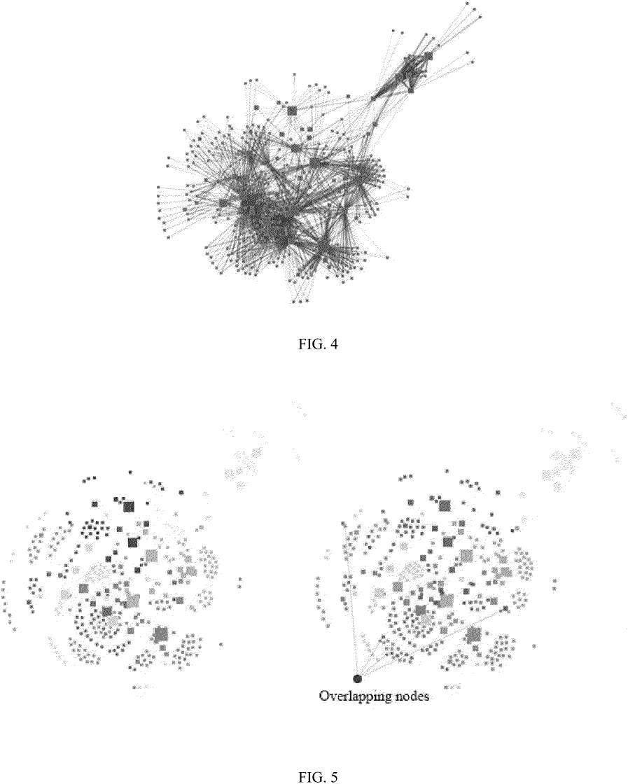

The layout of a two-zone single-channel warehouse has 402 kinds of materials stored in 7 storage racks with 11 columns and 6 floors. Through the analysis of more than 500 past retrieval and delivery documents, the material association network can be drawn as shown in FIG. 4. Then the importance of each material is calculated according to formula (1)-(4) as shown in the following table 1.

Table 1

Sorting of material importance degree

| Stock number | Importance degree | Importance degree ranking |
|---|---|---|
| 101111 | 0.0183 | 1 |
| 105403 | 0.0174 | 2 |
| 101910 | 0.0157 | 3 |
| 103179 | 0.0154 | 4 |
| 101512 | 0.0151 | 5 |
| 107778 | 0.0149 | 6 |
| 101142 | 0.0135 | 7 |
| 102489 | 0.0131 | 8 |
| 102497 | 0.0126 | 9 |

According to the rack capacity and the number of material types, the number of core nodes is set to 7, and the volume of communities is set to 66. Then, according to formulas (5)- (7), community expansion and overlapping node discovery are carried out. The expanded community structure and overlapping node distribution are shown in FIG. 5, and the volumes of the communities are 66, 65, 63, 58, 57, 54 and 39, which meet the rack capacity limit. According to the last step (5), slots are allocated for each material. The comparison between the slotting optimization method of associated articles based on a complex network proposed by the present disclosure and the common slot allocation methods is shown in the following table 2.

Table 2

Comparison of various slot allocation methods

| Slot allocation method | Average pick-up time per order (s) | Average number of times of cross-roadway retrievals per order |
|---|---|---|
| Random allocation strategy | 250.04 | 3.87 |
| Retrieval frequency allocation | 226.78 | 2.89 |
| Association rule allocation | 220.05 | 2.35 |
| Method of the present disclosure | 205.41 | 2.02 |

The above data show that compared with other common methods, the slotting optimization method of associated articles based on a complex network provided by the present disclosure has obvious effects in shortening the pick-up time and reducing the times of cross-roadway retrievals, and can better solve the slot allocation optimization problem of associated articles.

The above is only a preferred embodiment of the present disclosure, which is only used to help understand the present disclosure, and is not intended to limit the present disclosure. According to the concept of the present disclosure, those skilled in the technical field of the present disclosure can also make some simple deduction and deformation, such as designing corresponding slot allocation strategies according to other warehouse layout modes.

What is claimed is:

1. A slotting optimization method of associated articles based on a complex network, comprising following steps:
Step 1, constructing a weighted article association network G = (V, E, W) using warehoused articles as network nodes, and joint retrieval frequencies of pairs of articles as edges, where V is a node set, which is a set of articles to be stored in a warehouse; E is a set of edges eᵢⱼ, where i, j ∈ V, eᵢⱼ ∈ E, namely a set of strong and weak associations between articles; W is a weight matrix, wᵢⱼ corresponds to a weight of eᵢⱼ, with a value equal to a frequency of retrieving articles i,j at the same time, which reflects a strength of the association between articles nodes; wherein independent nodes are deleted them from the association network when the independent nodes exist;
Step 2, performing sorting on an importance Cᵢ (i) of an article node i by comprehensively taking into account a closeness centrality C_{c}(i) of each article node and an importance level contribution value
$$\frac{{w}_{i j} {s}_{i}}{{\left〈s\right〉}^{2}}$$
to each article node of a neighboring node thereof, where sᵢ is a strength of the node i, 〈s〉 is an average strength of all nodes, and determining a core node as a community expansion starting point;
Step 3, determining a community structure of an article association network using the capacity of each storage rack as a community volume limit and using weighted modularity Q^{w} and weighted dependency D_{i,c}ʹ as expansion criteria;
Step 4, determining whether a community peripheral node is an overlapping node according to a strength of an association relationship of the community peripheral node with another community; and
Step 5, determining a slot allocation for each article by comprehensively taking into account the community structure of the article association network and a retrieval frequency of the article itself.

2. The slotting optimization method of associated articles based on a complex network according to claim 1, wherein Step 2 comprises:
(a) analyzing a basic structure of the weighted article association network, and the closeness centrality of each article node is calculated;
wherein in the weighted article association network, the strength sᵢ of the node i is equal to a sum of the weights of the edges connected thereto:
$${s}_{i} = {\sum }_{j ∈ {N}_{i}} {w}_{i j}$$
where Nᵢ represents a set of neighboring node set of the node i, that is, a set of all the nodes associated with the node i;
a shortest path between any two nodes in the weighted network is a most vulnerable branch, that is:
$${d}_{i j}^{w} = min \left[\left(M - {w}_{i {h}_{1}}\right) + ... \left(M - {w}_{{h}_{n} j}\right)\right]$$
where hₙ is a midway node of each branch of i, j and M is a large number;
at this time, the closeness centrality of each node is equal to the reciprocal of a sum of the shortest paths from the node to all other nodes multiplied by a number of other nodes, that is:
$${C}_{c} \left(i\right) = \frac{n - 1}{{\sum }_{i \neq j} {d}_{i j}^{w}}$$
where n is a total number of the nodes in the network;
(b) sorting the importance of an article node according to the closeness centrality of the article node and an importance level contribution value to the article node of a neighboring node thereof;
wherein in an article association weighted network with the number of nodes being n and the average strength being (s), the node i contributes
$$\frac{{w}_{i j} {s}_{i}}{{\left〈s\right〉}^{2}}$$
of the importance level thereof to a neighboring node j thereof; when an edge weight between the node j and the node i is greater or the strength of the node ^{f} is greater, the importance level contribution of the node i to the node j is greater; the importance level Cᵢ(i) of the node is obtained by comprehensively taking into account the closeness centrality of the node and importance level contribution values to the node of all neighboring nodes:
$${C}_{i} \left(i\right) = {C}_{C} \left(i\right) \times {\sum }_{j = 1 , j \neq i}^{n} {C}_{C} \left(j\right) {δ}_{i j} {w}_{i j} {s}_{j} / {\left〈s\right〉}^{2}$$
where δᵢⱼ represents the connectivity between two nodes, which is 1 in case of connection, or 0 in case of non-connection;
(c) determining the volumes of communities and the number of communities according to the total number of storage racks in the warehouse, the capacities of the storage racks and the number of nodes in the article association network, and then determining the composition of the core node and the community expansion starting point according to the number of the communities and the sorting of the importance of the article node, wherein a community is a group of nodes in the complex network that are closely connected with each other but sparsely connected with other nodes.

3. The slotting optimization method of associated articles based on a complex network according to claim 1, wherein the Step 3 comprises:
(a) adding the neighboring nodes of each core node into a set of expanded candidate nodes of each community, and calculating a modularity increment ΔQ^{w} of each node in the set of candidate nodes to join the corresponding community:
$$Δ {Q}^{w} = \left[\frac{\sum {w}_{{C}_{j}}^{i n} + {\sum }_{j ∈ {C}_{j}} {w}_{i , j}}{2 w} {\left(\frac{\sum {w}_{{C}_{j}} + {s}_{i}}{2 w}\right)}^{2}\right] - \left[\frac{\sum {w}_{{C}_{j}}^{i n}}{2 w} - {\left(\frac{\sum {w}_{{C}_{j}}}{2 w}\right)}^{2} - {\left(\frac{{S}_{i}}{2 w}\right)}^{2}\right]$$
$$w = \frac{{\sum }_{i = 1}^{n} {\sum }_{j = 1}^{n} {w}_{i j}}{2}$$
where w represents a total weight value of the edges in the weighted network,
$$\sum {w}_{{C}_{j}}^{i n}$$
represents a sum of the edge weights in the community,
$${\sum }_{j ∈ {C}_{j}} {w}_{i , j}$$
represents a sum of weights of all edges connecting the node i and the nodes in the community Cⱼ, and
$$\sum {w}_{{C}_{j}}$$
represents a sum of weights of all edges associated with the nodes in the community;
(b) selecting a node with the largest modularity increment to join the community; in case the node has joined other communities, comparing the modularity changes of the node when the node belongs to two communities; in case the modularity increment caused by the node joining a new community is greater than the modularity increment that keeps the node in an original community, deleting the node from the original community and join the new community; iterating this process until the community structure no longer changes and meets the requirements or ΔQ^{w} is less than 0; in case an independent node exists at this time, calculating the dependency D_{i,C}ʹ of the node on a neighboring community C, selecting a neighboring community that has not reached the community volume according to dependency sorting, and adding the node to the neighboring community,
$${D}_{i , C} ' = \frac{{\sum }_{j ∈ C} {w}_{i , j}}{{s}_{i}}$$
.

4. The slotting optimization method of associated articles based on a complex network according to claim 1, wherein the Step 4 comprises:
(a) adding a node on the edge of the community and connected with other communities to a set U of potential overlapping nodes, and calculating the modularity increment
$$Δ {Q}_{j n}^{w} '$$
of each potential overlapping node joining other communities;
(b) calculating the modularity increment
$$Δ {Q}_{j}^{w} '$$
that keeps the node in the original community, and when a difference between
$$Δ {Q}_{j n}^{w} '$$
and
$$Δ {Q}_{j}^{w} '$$
is less than
$$\frac{5}{2 w} ,$$
affirming that the potential overlapping node has overlap with other communities;
(c) calculating a number of truly overlapping nodes between two communities, and determining a degree of overlap between communities by dividing the number by a sum of the nodes of the two communities.

5. The slotting optimization method of associated articles based on a complex network according to claim 1, wherein the Step 5 comprises:
formulating a slot allocation strategy according to a layout of the warehouse and the divided community structure;
firstly, sorting the retrieval frequency of each divided community, and allocating the community to each roadway of the warehouse one by one according to the ranking of the community; in case free storage racks still exists in the roadway after a community is allocated, taking into account the overlapping degree among various communities and placing high overlapping communities with an overlapping degree higher than 10% on other storage racks in the same roadway; when the number of the high overlapping communities is greater than the number of remaining storage racks, determining which high overlapping community the remaining storage racks belong to according to the community retrieval frequency; when no high overlapping community with an overlapping degree higher than 10% exists, allocating the remaining storage racks according to the retrieval frequency of each community; then allocating the slots in the rack wherein retrieval across the roadway must be performed via a roadway entrance under a single-channel layout, as a result, no matter which roadway the overlapping community of an overlapping articles is located in, the distance between the overlapping community and the article is capable of being reduced by placing the article closer to the roadway entrance in the original community, and thereby adopting an evaluation function Sᵢ to determine the slot arrangement of the article in the community:
$${}_{{S}_{i} = α {\frac{C O {I}_{i}}{max C O I}}_{{C}_{j}} + β {δ}_{i} \frac{{\sum }_{j n = 1}^{J N} {\sum }_{j ∗ ∈ {C}_{j n}} {w}_{i , j ∗}}{{\sum }_{j ∈ {C}_{j}} {w}_{i , j}}}$$
where COIᵢ represents a retrieval frequency of the article i;
$$max C O {I}_{{C}_{j}}$$
represents a maximum retrieval frequency of the articles in the community;
$${\sum }_{j * ∈ {C}_{j n}} {w}_{i , j *}$$
represents a sum of the weights of the connecting edges of an overlapping article i and an overlapping community Cⱼₙ ; when there is more than one overlapping community of i, for example, there are JN overlapping communities,
$${\sum }_{j n = 1}^{J N} {\sum }_{j * ∈ {C}_{j n}} {w}_{i , j *} ,$$
which represents a sum of weights of the connecting edges of the overlapping article i and all the external overlapping communities to which the overlapping article belongs;
$${\sum }_{j ∈ {C}_{j}} {w}_{i , j}$$
represents a sum of weights of the connecting edges of the overlapping article i and the community Cⱼ to which the overlapping article really belongs; δᵢ is a variable of 0-1; if i is an overlapping article, then δᵢ=1, and if i is not an overlapping article δᵢ =0; α, β represent the weights of the two major components of the evaluation function, α + β = 1, and then the arrival time of each slot in the rack is calculated, wherein t = t_{walk} + tᵣₑₜᵣᵢₑᵥₐₗ in a manual picking warehouse, namely a sum of a walking time and a vertical pick-up time after standing; the matching between articles and slots is completed according to the scoring and sorting of the evaluation function of the article and the sorting of the slot arrival time;
finally, allocating possible independent nodes to spare slots according to the retrieval frequency.
